(19) United States
(12) Patent Application Publication
(10) Pub. No.: US 2015/0246798 A1
(43) Pub. Date: Sep. 3, 2015

(54) AUXILIARY RAMP FOR TIRE CHANGING IN MOTOR VEHICLES

(71) Applicant: Roberto GUZMÁN RESTORI, Huachinango, Puebla (MX)

(72) Inventor: Roberto Guzman Restori, Huauchinango (MX)

(21) Appl. No.: 14/431,934

(22) PCT Filed: Sep. 25, 2013
(86) PCT No.: PCT/MX2013/000114

§ 371 Date: Mar. 27, 2015

(30) Foreign Application Priority Data
Sep. 27, 2012 (MA) MA/U/2012/000430

(51) Int. Cl. B66F 7/24

(52) U.S. Cl. CPC B66F 7/243

(57) ABSTRACT

An auxiliary ramp is designed to ease the task of replacing a tire on a motor vehicle. In one embodiment, the body of the ramp is a rectangular prism with a diagonal cut in the front end of it, allowing a vehicle to go on it. A diagonal cut in the bottom rear area with wheels enabling the ramp to slide when necessary, an audible warning device is configured to indicate the right position on the ramp to perform the tire change. The ramp allows a user to easily raise the car and the tire subject to replacement. By using it, the car will reach a better height for jack insertion preventing any excessive effort when lifting the vehicle.

### RELATED APPLICATIONS

This is a national phase application of PCT application No. PCT/MX2013/000114, filed Sep. 25, 2013, which claims the priority of Mexican application No. MA/U/2012/000430, filed Sep. 27, 2012. The disclosure of the above-identified applications is incorporated by reference herein in its entirety.

### FIELD OF THE INVENTION

Embodiments of the present invention relate generally to accessories for motor vehicles. More particularly, embodiments of the invention relate to a support ramp for lifting a vehicle to a certain height in order to significantly facilitate changing tires.

### BACKGROUND

When changing a tire on any vehicle, it is required to raise the vehicle at a certain height allowing us to perform the operation, using a vehicle-lifting device also known as a “jack.” However considerable effort and no fewer complications are required to do so, this is because sometimes a “jack” can't lift the vehicle at all or it does not fit underneath the vehicle, or requires a double or triple lifting in order to reach the needed height for tire changing. Sometimes lack of strength and/or abilities can prevent a clean and flawless tire replacement.

This previous description summarizes the hassle involved in such task, so the use of this ramp will substantially reduce the complications and effort required. Thereby making the change of a tire an easy job for anyone.

### BRIEF DESCRIPTION OF THE DRAWINGS

Embodiments of the invention are illustrated by way of example and not limitation in the figures of the accompanying drawings in which like references indicate similar elements.

FIGS. 1-8 show various embodiments of an auxiliary ramp for replacing a tire of a motor vehicle.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, an auxiliary ramp is designed to ease the task of replacing a tire on a motor vehicle. In one embodiment, the body of the ramp is a rectangular prism with a diagonal cut in the front end of it, allowing a vehicle to go on it. A diagonal cut in the bottom rear area with wheels enabling the ramp to slide when necessary, an audible warning device is configured to indicate the right position on the ramp to perform the tire change. The ramp allows a user to easily raise the car and the tire subject to replacement. By using it, the car will reach a better height for jack insertion preventing any excessive effort when lifting the vehicle. In one embodiment, a ramp as described below, can be fabricated of one of several materials such as; metal, plastic, or wood and it would come in a variety of sizes.

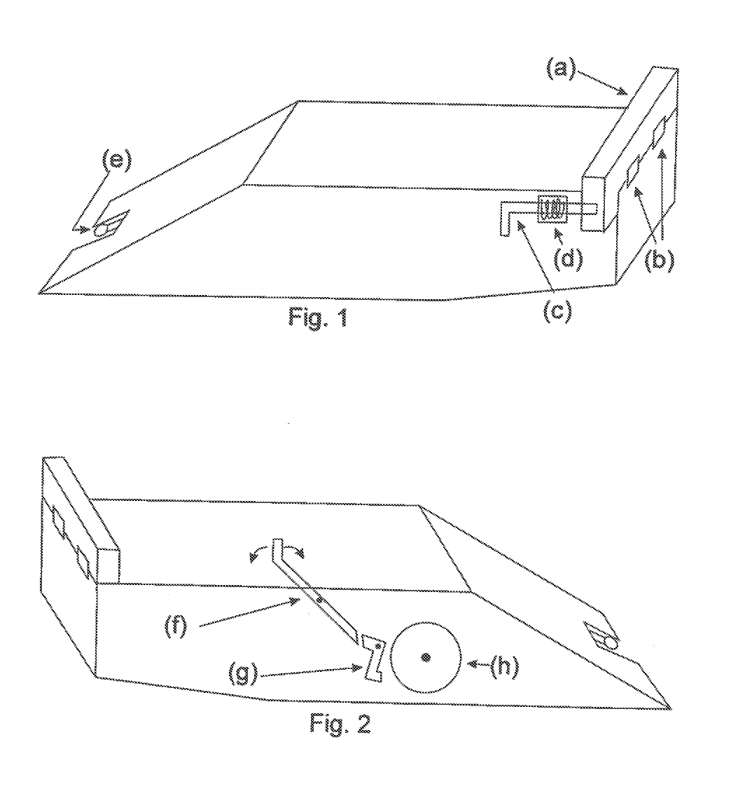

Referring to FIG. 1; in one embodiment, a ramp includes a rectangular prism shape with a diagonal cut in the front end (a) defining a portion of the ramp. On the bottom rear end it has a diagonal cut (b), where the wheels are located (c), and the top rear part has a fixed or moving stopper (d), mounted on hinges (e) which has a fastening bolt (f), spring (g), coupled to swing stopper when actuated abate the top, and the bottom front of one eyelet to hook (h).

This ramp has an optimal positioning warning ringer device and safety slide wheels if gone beyond the optimal spot. This warning ringer device could be either mechanical or electronic be presented in a variety of shapes.

A ramp with mechanical audible warning device is shown in FIG. 2 according to one embodiment. The device consists of an actuating lever (i), which is activated by contact with the tire of the vehicle. A trigger (j), with torsion spring coupled to the operating lever that triggers a hammer hitting a bell (k).

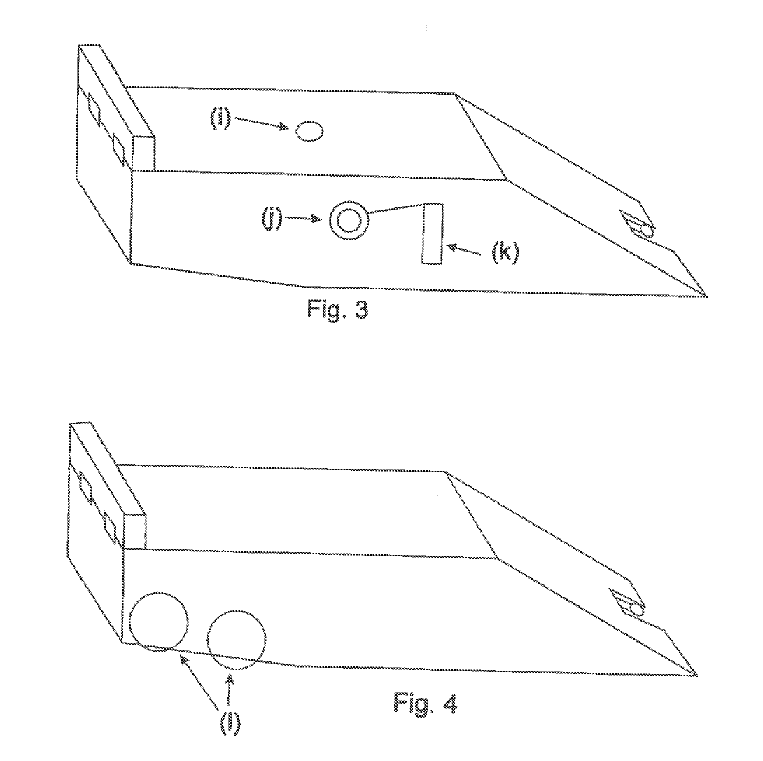

A ramp with electronic warning device is shown in FIG. 3 according to one embodiment. The device includes a switch button (l), located at the top of the ramp, which when depressed by the flat tire triggers a buzzer (m), powered by a battery (n).

The audible warning device is very useful because it tells us when the tire subject of replacement is positioned on the right spot on the ramp.

Safety advance wheels: when the tire is already in the right position and for some reason the driver of the vehicle keeps moving forward, even when the audible warning went off and wasn't heard or ignored, the ramp will tilt forward on these wheels allowing the vehicle to move without going over the ramp. The ramp has four wheels as shown in FIG. 4. Occasionally these wheels serve to withdraw and release the ramp from underneath the tire.

This invention described and shown in the drawings, is a ramp designed and built to significantly reduce the stress anyone suffers when facing the need to remove or change a tire. Especially when the tire is almost or completely flat. This device aids us to lift the car to an optimal position for such labor.

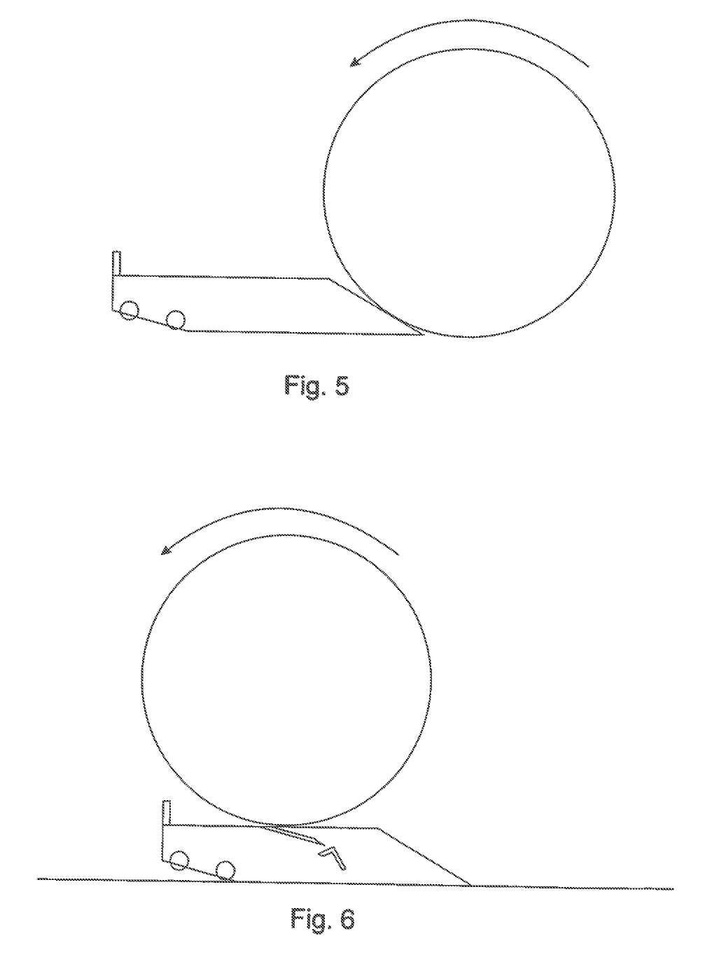

During the operations, according to one embodiment, the ramp is placed in front of the tire subject of replacement, as shown in FIG. 5, at this point the vehicle is should advance slowly over the ramp until the tire triggers the audible alarm, as shown in FIG. 6. When this occurs the vehicle should come to a full stop. Now the car is at a more comfortable height to easily insert the jack and lift just a few more inches.

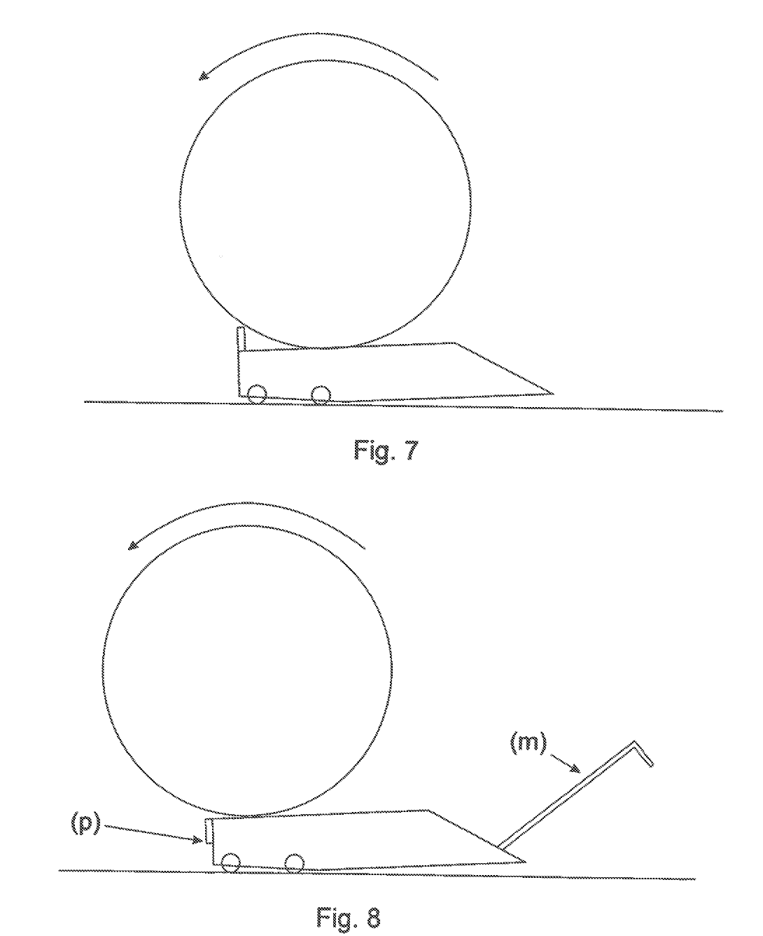

If the warning sound is ignored and the vehicle keeps moving forward, the ramp will tilt over the wheels and will slide along with the vehicle, preventing further damage and a possible fall off the ramp, as shown in FIG. 7.

Sometimes these wheels serve to remove the ramp after placing jack and lifting the vehicle a little. FIG. 8 by pulling a hook (p), from the front of the ramp on the folded top (q). However the ramp is normally removed when performing the tire change.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An auxiliary ramp for replacing a tire of a motor vehicle, comprising:
a ramp body substantially in a rectangular prism shape having a frontend portion and a rear bottom portion, wherein the frontend portion includes a first diagonal cut defining a ramp shape, wherein the rear bottom portion includes a second diagonal cut in a longitudinal shape;
a stopper located on a top back area of the ramp body;
at least one pairs of wheels arranged in the rear bottom portion of the ramp body on the second diagonal cut; and
an audible warning device placed on an upper body of the auxiliary ramp, so that when activated by the tire the audible warning device produces an audible warning.

2. The auxiliary ramp of claim 1, wherein the audible warning device is a mechanical device and comprises:
a lever that is activated upon contact with a tire of the motor vehicle;
a trigger having a spiral spring coupled to the lever; and
a bell which is struck by an action of the trigger.

3. The auxiliary ramp of claim 1, wherein the audible warning device is an electrical device and comprises a switch button arranged on the upper body of the auxiliary ramp, which when depressed triggers a battery powered buzzer or bell.

4. The auxiliary ramp of claim 1, further comprising a stopper plate that is collapsible, wherein the stopper plate comprises a fastening bolt and a spring coupled to a hinged stopper plate.

5. The auxiliary ramp of claim 1, further comprising a metal ring located in the frontend portion of the ramp body in order to pull the auxiliary ramp if necessary with a hook.
